(19) United States
(12) Patent Application Publication
(10) Pub. No.: US 2006/0242187 A1
(43) Pub. Date: Oct. 26, 2006

(54) Type safe data proxy

(76) Inventor: Michael Scharf, Heidelberg (DE)

Correspondence Address: FAY KAPLUN & MARCIN, LLP, 15O BROADWAY, SUITE 702, NEW YORK, NY, 10038, US

(21) Appl. No.: 11/114,951

(22) Filed: Apr. 26, 2005

(51) Int. Cl. G06F 17/00

(52) U.S. Cl. 707/102

(57) ABSTRACT

Described is a method for reading a data structure in a first code language, generating an implementation of the data structure and executing a call to the implementation of the data structure to obtain information describing the data structure. The method further includes mapping the data structure to a generic data structure using the information and writing the generic data structure in a second code language, wherein access to the generic data structure is type-safe.

### BACKGROUND INFORMATION

Many organizations use a patchwork of closed development tools and sites that prevent collaboration among developers, projects and sites. Also, with the average device containing in the range of one million lines of code, product lifecycles shrinking to less than one year and project teams distributed across the globe, these organizations are facing ever increasing complexity and time-pressure in developing device software.

Extensible Markup Language (XML) is widely used to make data persistent, and thereby overcome problems in collaboration among developers, projects and sites. XML allows the developers to create custom tags, thereby enabling definition, transmission, validation and interpretation of the data between applications and organizations. However, many software programmers would prefer to convert their output from their native format (e.g., Java) to the XML format without having to learn the nuances of XML or a tool that converts the data to XML. Additionally, the programmers would prefer that the converted data be type safe. That is, code that accesses only the memory locations it is authorized to access, and only in well-defined, allowable ways.

### SUMMARY OF THE INVENTION

A method for reading a data structure in a first code language, generating an implementation of the data structure and executing a call to the implementation of the data structure to obtain information describing the data structure. The method further includes mapping the data structure to a generic data structure using the information and writing the generic data structure in a second code language, wherein access to the generic data structure is type-safe.

In addition, a method including reading an interface, the interface including a method, generating an attribute for the method, inputting the attribute into a schema tree and converting the schema tree into a concrete schema.

Furthermore, a system comprising a memory to store a set of instructions and a processor to execute the set of instructions, the set of instructions being operable to read a data structure in a first code language, generate an implementation of the data structure, execute a call to the implementation of the data structure to obtain information describing the data structure, map the data structure to a generic data structure using the information and write the generic data structure in a second code language, wherein access to the generic data structure is type-safe.

### BRIEF DESCRIPTION OF DRAWINGS

FIG. 1 shows an exemplary embodiment of a method for converting data according to the present invention.

FIG. 2 shows an exemplary embodiment of a method for creating a schema according to the present invention.

FIG. 3 shows an exemplary embodiment of a method for imposing a constraint according to the present invention.

### DETAILED DESCRIPTION

The present invention may be further understood with reference to the following description and the appended drawings, wherein like elements are provided with the same reference numerals. There are three distinct approaches to making XML-formatted data available to Java. A first approach is a hand-coded Java data structure and a hand written (or introspection-based) reader and writer. As would be understood by those skilled in the art, the reader and the writer are usually based on a Simple API for XML (SAX). The SAX is an event-based API that allows someone to access the contents of an XML document. The SAX does not hold a document tree in a memory, but presents a view of the XML document as a sequence of events. For example, the SAX reports every time it encounters a begin tag and an end tag. The SAX is a lightweight API for fast reading. The SAX does not support modifications or random access to the XML document. Other problematic aspects of hand-coded Java data structures are that there is a high error rate and evolution is difficult. However, the SAX does provide type-safe data access.

A second approach to making XML-formatted data available to Java is a code generator which uses a schema definition language (e.g., XML Schema, DTD) to specify the structure of the generated XML code. The schema definition language states tags and attributes that are used to describe content in an XML document, where each tag is allowed and which tags can appear within other tags. Similar to the hand-coded Java data structures described above, the data access to the generated XML code is type safe. However, the programmer would have to learn the syntax of the schema definition language (e.g., XML Schema, DTD). Other disadvantages associated with utilizing the code generator are that a great deal of code is generated that must be managed, code generation tools may not be available on all platforms and the code generator has to be integrated into a make-system, which is used to configure a code-building operation.

A third approach to making XML-formatted data available to Java is a generic data structure (e.g., DOM, JDOM) which accesses the data in a generic way (e.g., like a map). A generic interface, such as a Document Object Model (DOM), allows the programmer to represent the data structure without having to write or generate additional code. The DOM is a specification for how objects (e.g., text, images, headers, links, etc.) in a web page are represented. Using the DOM, the XML document tree is fully loaded in memory, and the DOM can perform almost every conceivable XML task. In other words, the DOM is a large API, but the same API across multiple languages. However, DOM does not typically come natural to most Java programmers who expect typical Java capabilities, such as method overloading, use of standard Java object types and simple set and get methods. DOM further requires increased processing power and memory. Therefore, DOM is not a lightweight API which would be useful in web applications and programs. Also, a noticeable disadvantage of using a DOM is that the data access is not type safe. Because the data access is not type safe, a Java compiler cannot help to find mismatches between an externally defined schema and a use in the code. As is known by those skilled in the art, JDOM is a Java Document Object Model that represents the XML document and its contents to a Java programmer. The advantages and disadvantages associated with the DOM are also present when utilizing the JDOM.

In view of the approaches described above and the disadvantages associated with each, the exemplary embodiment of the present invention seeks to provide a programmer with the ability to express an XML schema using a Java interface, wherein a resultant data access is type safe. The exemplary embodiment of the present invention further provides for the generation of an external representation of the XML schema. Though the exemplary embodiment of the present invention will be described with respect to the Java interface and the XML schema, those skilled in the art would understand that the present invention may be used to make one form of data available to a second form of data.

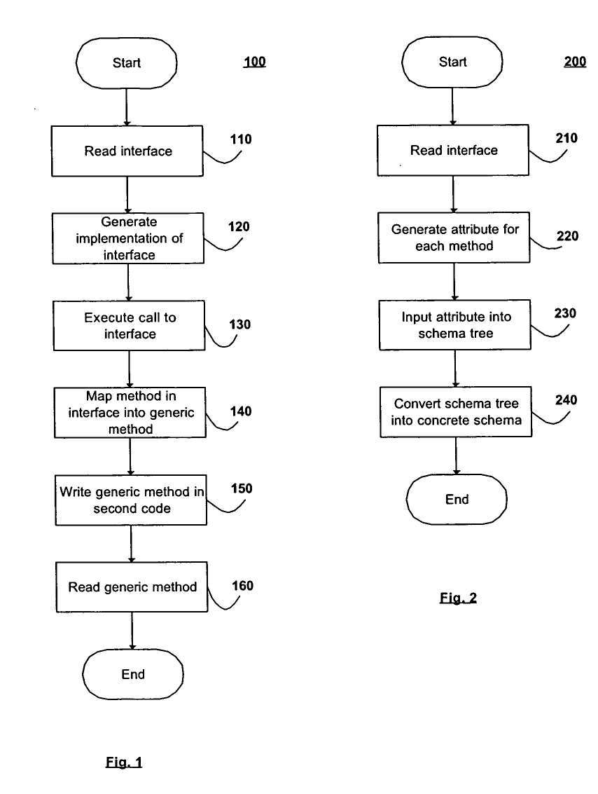

A method according to the present invention is represented schematically in FIG. 1 and shown generally at 100. The method 100 may be utilized on a system designed for building an Integrated Development Environment (IDE), which can be used to create applications, such as web sites, embedded Java programs, C++ programs, JavaBeans, etc. As would be understood by those skilled in the art, the system utilizing the method of the present invention may be a platform, such as Eclipse, which is an open extensible IDE for creating applications, and/or Wind Power IDE, developed by Wind River Systems, Alameda, Calif.

In step 110, the system reads an interface in a first code input by a programmer, program or subroutine. The first code may describe a data structure (e.g., file, list, array, record, tree, table, etc.) desired by the programmer. Furthermore, the first code may describe the data structure in terms of an interface, and the interface may implement a method. In this manner, the interface may be a Java interface using well-known JavaBean-like naming conventions. For example, the following naming conventions may represent set and get methods for an attribute (or a property) named myAttribute:

void setMyAttribute (AttributeType value);
AttributeType getMyAttribute( );.

Additionally, an example of an object array using the naming conventions described herein is shown below:

void addMyAttribute (AttributeType value);
void clearMyAttributes( );
AttributeType[ ] getMyAttributes( );.

However, when the attribute is the interface itself, the set method and an add method may be slightly different, because the methods return a new object of an expected data type. An exemplary embodiment of the interface is shown as follows:

AttributeType setMyAttribute( );
AttributeType addMyAttribute( );.

Exemplary interfaces which would utilize the above-stated methods are shown as follows:

interface Person {

String getName( );
void setName (String name);
Date getBirthday( );
Date setBirthday( );
Skill[ ] getSkills( );
Skill addSkill( );
void clearSkills( );

}
interface Date {

int getYear( );
String getMonth( );
int getDay( );

}
interface Skill {

String getName( );
int getLevel( );

}.

As would be understood by those skilled in the art, the above code serves as examples of the naming conventions that may be used to input the first code and/or the interface of the first code.

In step 120, the system generates an implementation of the interface. In the case of the Java interface, the implementation of the Java interface is a Java proxy that is created at runtime using a Java proxy system (e.g., java.lang.reflect.Proxy). As would be understood by those skilled in the art, the class Proxy provides a static method for creating a proxy class. The proxy class is a class that implements a list of interfaces (e.g., the Java interface) specified at runtime, such that a method invocation through one of its interfaces on an instance of the proxy class will be encoded and dispatched to another object through a uniform interface. Thus, the proxy class can be used to create a type-safe proxy object for a list of interfaces without requiring pre-generation of the proxy class, such as with compile-time tools. Proxy classes are useful to an application or a library that needs to provide type-safe reflective dispatch of invocations on objects that present interface APIs. According to the present invention, the proxy class implements the Java interface that is specified at runtime when the proxy class is created.

The static method in the class Proxy also creates a proxy instance. The proxy instance is an instance of the proxy class. Each proxy instance has an invocation handler associated with it that implements the Java interface. According to the present invention, the proxy instance is the instance of the proxy class which will implement the Java interface described by the programmer.

In step 130, the Java proxy uses the invocation handler associated with the proxy instance to execute a call to the Java interface. As a result of this call, the invocation handler may read a set of values associated with the interface. For example, the set of values may include the method name (e.g., set, get, add), a parameter(s) and/or an expected return type defined by the Java interface. As would be understood by those skilled in the art, the Java interface created by the programmer may not contain the parameter(s).

In step 140, the system maps the method (e.g., set, get, add) in the Java interface into a generic method. According to the present invention, the invocation handler knows the generic method. For example, as described above, the get method may be written as AttributeType getMyAttribute( ). The system maps the get method AttributeType getMyAttribute( ) into the generic method Object get(“MyAttribute”), which is known by the invocation handler. According to the present invention, the invocation handler may know further generic methods, such as, for example, the following generic methods:

Object get(String attribute);
boolean has(String attribute); //returns true if the

attribute value is defined

void set(String attribute, Object value);
void clear(String attribute);
void add(String attribute, Object value);.

As described above, an embodiment of the invention is contemplated wherein the attribute is the interface. For example, the attribute MyAttribute may be the interface as follows:

AttributeType setMyAttribute( );
AttributeType addMyAttributes( );.

In this case, the invocation handler may generate the Java proxy for that interface. As understood by those skilled in the art, the Java proxy generated by the invocation handler for the interface will allow the system to create implementations of a recursive data structure (e.g., a linked list, a tree, a hash table, etc.).

In step 150, the system uses a writer to convert the data structures written in the first code in the Java interface to a generic data structure in a second code. The writer first gets the generic method (e.g., Object get(“MyAttribute”)) created by the invocation handler, and writes the data structures contained in the generic method into a stream of the generic data structures in the second code. The generic data structure written into the stream in the second code may include any attributes, children and subchildren associated with the data structures written in the first code. In the above example, the writer may be an XML Writer that writes all the attributes, children and subchildren of the generic method to the generic data structures in an XML stream. As would be understood by those skilled in the art, writing to the stream of the second code may be accomplished in a similar manner to a DOM writer. Thus, the writer may define the attributes that are associated with each object (e.g., the data structure), and how the object and the attributes can be manipulated.

In step 160, a reader is used to read the generic data structures in the second code from the stream. The reader reads the second code into the generic method, which may be accomplished in a similar manner to a DOM reader. The generic data structure may then be returned as a proxied object to the programmer. Thus, the data structure initially written in the first code is returned to the programmer as the generic data structure represented in the second code. Also, an access to the generic data structure will be type-safe. According to the present invention, the programmer does not have to maintain any additional code, as would be the case with the code generators. Also, the programmer does not have to learn another language (e.g., XML) or tool (e.g., Java to XML data converter).

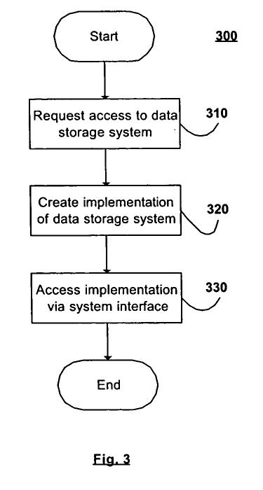

A further aspect of the present invention is a method, shown at 200, to generate a schema of the second code. As seen in FIG. 2, in step 210, the system reads the interface created by the programmer. As described above, the interface may include the description of the data structures written in the first code (i.e., Java). As would be understood by those skilled in the art, the system may read the individual interface, a predetermined number of interfaces or the entire set of interfaces created by the programmer.

In step 220, the system uses an introspector to generate the attribute for each method. In this manner, the introspector may iterate over all methods in contained within the interface to extract the attribute(s) (or property) associated with each interface. For example, the introspector may generate the attribute for the getMyAttribute( ) and setMyAttribute( ) methods.

In step 230, the attribute generated for each method is input into a schema tree. In one embodiment of the present invention, the schema tree may be constructed and represented in a graphical user interface (GUI). The GUI may allow the programmer to customize the input to the schema tree by adding/deleting/modifying a node in the schema tree, including a parent, child or subchild of the node. In a further embodiment of the present invention, a program or a subroutine may input the attribute into the schema tree.

In step 240, a schema generator converts the schema tree into a concrete schema. The concrete schema may be an external representation of an XML Schema. As would be understood by those skilled in the art, the concrete schema may be a document type definition (DTD), an interactive data language (IDL) or any other different type of schema. According to the present invention, the programmer is not required to know anything about a competing XML Schema description language, because the data structures are expressed in Java.

In a further embodiment of the present invention, the system may allow the programmer to utilize a variety of hierarchical data storage systems. As seen in FIG. 3, a method for utilizing an existing data storage system is shown generally at 300. In step 310, the programmer desires access to or use of a data storage system. For example, the Java runtime data storage system comes with three generic storage systems: java.util.prefs.Preferences, java.util.Properties and DOM (org.w3c.dom). Additionally, further data storage systems may complement the IDE. For example, the Eclipse IDE has the generic data storage systems, IPreference and IMemento.

In step 320, the system creates an implementation of the data storage system. In this manner, each data storage system available to the programmer (e.g., java.util.prefs.Preferences, java.util.Properties and DOM) may have the implementation created for it. Each implementation is then available to the programmer via a system interface, and, as such, the programmer has access to and use of each data storage system. Thus, the programmer only has to learn the system interface and can have access to a variety of data storage systems.

In step 330, the programmer accesses the data storage system desired via the implementation of the data storage system available through the system interface. As stated above, the programmer does not have to learn the accessability, availability and restrictions on each data storage system.

In yet a further embodiment of the present invention, the system may allow the programmer to add a constraint to the Java interface in the form of a final attribute. The constraint is a final static member of the Java interface that has the same name as the attribute. Information regarding the constraint may be used in the GUI (e.g., IDE) or for the schema generator, described above.

In one aspect, the constraint may define a default value. For example, an implementation of the constraint as the default value is shown as follows:

final static Constraint number = new DefaultConstraint(42);
int getNumber( );
void setNumber (int number);.

In the above example, when the get method is called, in the absence of a value entered by the programmer, the constraint imposes the default value ‘42.’

In a second aspect, the constraint may restrict a range of values of the attribute. For example, the constraint may utilize a “one of” restriction, as shown below:

final static Constraint gender = new ChoiceConstraint

(new String[ ]{“male”, “female”});

String getGender ( );
void setGender (String gender);.

In the above example, a choice of the string gender is limited to “one of” male and female.

In a further aspect, the system may utilize a nested constraint. The nested constraint may be implemented with both the range of values and the default value as shown below:

new ChoiceConstraint (new String[ ]{“male”, “female”},

new DefaultConstraint(“male”))

The above example utilizes the “one of” restriction, in that the programmer is limited to a choice between male and female values for the attribute. Also, the nested constraint above utilizes the default constraint, in that in the absence of the choice made by the programmer, the attribute is given the default value, ‘male.’

In a further embodiment, a method of adding a new node in a tree is provided. For example, it may be desired to add a skill attribute to a person such as:

interface Person {

Skill[ ] getSkills( );

}

Thus, there must be a manner of creating a skill object compatible with the XML representation. An exemplary manner of doing this is by defining a method in Person, e.g., void addSkills( ). This method adds a new entry to the skills attribute. The underlying IDataStore may have a generic method such as addChild(String attribute). A call to person.addSkills( ) would be handled by the proxy by calling the addChild method of the data model. This shows an exemplary manner of adding a child node to an existing tree.

In the preceding specification, the present invention has been described with reference to specific exemplary embodiments thereof. It will, however, be evident that various modifications and changes may be made thereunto without departing from the broadest spirit and scope of the present invention as set forth in the claims that follow. The specification and drawings are accordingly to be regarded in an illustrative rather than restrictive sense.

What is claimed is:

1. A method, comprising:
reading a data structure in a first code language;
generating an implementation of the data structure;
executing a call to the implementation of the data structure to obtain information describing the data structure;
mapping the data structure to a generic data structure using the information; and
writing the generic data structure in a second code language, wherein access to the generic data structure is type-safe.

2. The method of claim 1, wherein the first code language is Java.

3. The method of claim 1, wherein the second code language is XML.

4. The method of claim 1, wherein the data structure is a Java interface.

5. The method of claim 1, wherein the information is one of a method name, a parameter and an expected return type.

6. The method of claim 5, wherein, when the expected return type is an interface, a proxy is generated for the implementation.

7. The method of claim 1, wherein the implementation includes a method.

8. The method of claim 7, wherein the method is one of a set method, a get method, a clear method and an add method.

9. The method of claim 1, further comprising returning the generic data structure as a proxied object to a user.

10. A method, comprising:
reading an interface, the interface including a method;
generating an attribute for the method;
inputting the attribute into a schema tree; and
converting the schema tree into a concrete schema.

11. The method of claim 10, wherein the interface includes a plurality of methods and the generating step includes generating attributes for each of the plurality of methods.

12. The method of claim 11, wherein the inputting step includes inputting each of the attributes into the schema tree.

13. The method of claim 10, wherein the schema tree is represented in a graphical user interface (GUI).

14. The method of claim 13, wherein the GUI is configured to allow a user to customize the schema tree.

15. The method of claim 14, wherein the customization includes one of adding a node, deleting a node and modifying a node.

16. The method of claim 10 wherein the concrete schema is one of an XML schema, a document type definition (DTD) schema and an interactive data language (IDL) schema.

17. A system comprising a memory to store a set of instructions and a processor to execute the set of instructions, the set of instructions being operable to:
read a data structure in a first code language;
generate an implementation of the data structure;
execute a call to the implementation of the data structure to obtain information describing the data structure;
map the data structure to a generic data structure using the information; and
write the generic data structure in a second code language, wherein access to the generic data structure is type-safe.
